(19) United States
(12) Patent Application Publication
(10) Pub. No.: US 2007/0166645 A1
(43) Pub. Date: Jul. 19, 2007

(54) Chalcogenide precursor compound and method for preparing chalcogenide thin film using the same

(76) Inventors: Hyun Dam Jeong, Suwon-Si (KR); Jong Baek Seon, Seoul (KR); Hyeon Jin Shin, Suwon-Si (KR); Sang Heon Hyun, Suwon-Si (KR)

Correspondence Address: CANTOR COLBURN, LLP, 55 GRIFFIN ROAD SOUTH, BLOOMFIELD, CT, 06002, US

(21) Appl. No.: 11/412,028

(22) Filed: Apr. 26, 2006

(30) Foreign Application Priority Data
Oct. 18, 2005 (KR) 2005-98143

(51) Int. Cl. G11B 7/24

(52) U.S. Cl. 430/270.13

(57) ABSTRACT

Disclosed herein are a soluble chalcogenide precursor compound and a method for preparing a chalcogenide thin film using the precursor compound by a solution deposition process, e.g., spin coating or dip coating. In the method, the use of the chalcogenide precursor as an inorganic semiconductor material soluble in organic solvents enables the preparation of a semiconductor thin film having excellent electrical and physical properties (e.g., crystallinity). In addition, a large-area thin film can be prepared by a solution deposition process, thus contributing to the simplification of procedures and reduction of preparation costs. Therefore, the method can be effectively applied in a wide variety of fields, such as thin film transistors, electroluminescent devices, photovoltaic cells and memory devices.

### BACKGROUND OF THE INVENTION

This non-provisional application claims priority under 35 U.S.C. § 119(a) to Korean Patent Application No. 2005-98143 filed on Oct. 18, 2005, the entire contents of which are hereby incorporated by reference.

### FIELD OF THE INVENTION

The present invention relates to a chalcogenide precursor compound and a method for preparing a chalcogenide thin film using the precursor compound. More particularly, the present invention relates to a chalcogenide precursor compound soluble in organic solvents and a method for preparing a chalcogenide thin film using the precursor compound by a solution deposition process, e.g., spin coating or dip coating.

### DESCRIPTION OF THE RELATED ART

Flat panel displays, such as liquid crystal displays and organic electroluminescent displays, include a number of thin film transistors (TFTs) for driving the devices. Thin film transistors comprise a gate electrode, source and drain electrodes, and a semiconductor layer activated depending on the driving of the gate electrode. A p-type or n-type semiconductor layer functions as a conductive channel material to facilitate the flow of current between the source and drain electrodes. The semiconductor layer is modulated by the applied gate voltages.

Semiconductor materials mainly used in thin film transistors are amorphous silicon (a-Si) and polycrystalline silicon (poly-Si). In recent years, a great deal of research has been conducted on organic semiconductor materials, such as pentacene and polythiophene.

One requirement for the use of organic semiconductor materials in the fabrication of thin film transistors is that the charge carrier mobility must be sufficiently high to attain good performance of the devices. An organic thin-film semiconductor material having the highest charge carrier mobility reported hitherto is known to be pentacene (˜2.7 square centimeter/Volt-second (cm²/Vs) at room temperature). A single-crystal semiconductor material having the highest charge carrier mobility is perylene (˜5.5 cm²/Vs), which is an n-type semiconductor material. These mobility values are higher than those of a-Si, but are much lower than those of poly-Si.

Although low molecular weight organic materials, e.g., pentacene, have a high charge carrier mobility and a high on/off current ratio (Iₒₙ/I_{off} ratio), they utilize expensive vacuum deposition apparatus during the formation of thin films and have a difficulty in forming fine patterns. Accordingly, low molecular weight organic materials are not suitable for the fabrication of large-area devices at low costs.

Unlike low molecular weight organic materials, high molecular weight organic materials, e.g., polythiophene, can be easily formed into thin films by solution deposition techniques, such as screen printing, ink-jet and roll printing techniques. For these reasons, high molecular weight organic materials are advantageously used in the fabrication of large-area devices at low costs. However, high molecular weight organic materials have different oxidation potentials because of differences in molecular weight distribution. This gives rise to instability. In addition their application to the fabrication of devices presents considerable difficulties. In addition, high molecular weight organic materials have a mobility as low as 1 cm²/Vs, and thus there are some limitations in the application to low-priced logic devices, low-priced flexible displays, RFIDs, and the like.

Various attempts have been made to develop inorganic semiconductor materials, such as silicon-based semiconductor materials with covalent bonding. These can achieve high charge carrier mobility and can be prepared by a low-cost process, such as solution deposition, and methods for preparing the semiconductor materials.

For example, thin film transistors have been proposed that comprise a cadmium sulfide (CdS) film deposited by a chemical bath deposition (CBD) method as a semiconductor active layer (DuPont, Thin Solid Films 444 (2003) 227-234). However, this deposition method suffers from problems of low deposition speed and disadvantageous applicability to processing arising from the use of a chemical bath.

Further, CdS thin films prepared by an electrostatic spray-assisted vapor deposition (ESAVD) technique have been suggested as window layers for heterojunction thin film photovoltaic cells (Thin Solid Films 359 (2000) 160-164). According to the ESAVD technique, a charged aerosol is induced toward the substrate by an applied electrostatic field. This eliminates the use of high-vacuum apparatuses and hence the coating efficiency is advantageously improved. However, the ESAVD technique poses a problem in that the surface state of the thin films is non-uniform when compared to that of thin films prepared by spin coating.

U.S. Pat. No. 6,875,661 and U.S. Patent Publication No. 2005/0009225 disclose methods for depositing a metal chalcogenide thin film using a precursor solution containing a metal chalcogenide and a hydrazine compound. The metal chalcogenide thin film is prepared by solution deposition. According to the methods, a soluble precursor solution comprising chalcogenide hydrazinium salt is prepared followed by spin coating, to prepare the thin film. Since the chalcogenide hydrazinium salt is chemically unstable, it tends to deteriorate when stored over a period of time. As a result, these methods are expensive and are not suitable for practical application to device fabrication lines.

### SUMMARY OF THE INVENTION

Therefore, the present invention provides a soluble chalcogenide precursor compound bound with a ligand.

The present invention also provides a method for preparing a chalcogenide thin film using the chalcogenide precursor compound by solution deposition processes, e.g., spin coating or dip coating, so that the electrical and physical properties (e.g., crystallinity) of the thin film are improved and large-area coating is possible, achieving a reduction in the preparation costs.

The present invention also provides a device comprising a chalcogenide thin film prepared by the method as a carrier transport layer.

The present invention also provides a chalcogenide precursor compound represented by Formula 1 below:

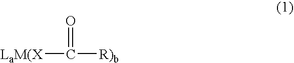

wherein L is a ligand having a nitrogen atom with an unshared pair of electrons;

M is a metal atom selected from the group consisting of Group II, III and IV elements;

X is a Group VI chalcogen element;

R is hydrogen, substituted or unsubstituted C₁-C₃₀ alkyl, substituted or unsubstituted C₁-C₃₀ alkenyl, substituted or unsubstituted C₁-C₃₀ alkynyl, substituted or unsubstituted C₁-C₃₀ alkoxy, substituted or unsubstituted C₆-C₃₀ aryl, substituted or unsubstituted C₆-C₃₀ aryloxy, substituted or unsubstituted C₂-C₃₀ heteroaryl, substituted or unsubstituted C₂-C₃₀ heteroaryloxy, or substituted or unsubstituted C₂-C₃₀ heteroarylalkyl;

a is an integer from 0 to 2; and

b is 2 or 3.

In accordance with another aspect of the present invention, there is provided a method for preparing a chalcogenide thin film which comprises the steps of i) dissolving the chalcogenide precursor compound of Formula 1 in an organic solvent to prepare a precursor solution, and ii) applying the precursor solution to a substrate, followed by annealing.

In accordance with yet another aspect of the present invention, there is provided a device comprising a chalcogenide thin film prepared from the chalcogenide precursor compound. The chalcogenide thin film serves as a carrier transport layer. The device can be fabricated by spin coating at room temperature and has superior electrical conductivity and thin film crystallinity.

### BRIEF DESCRIPTION OF THE DRAWINGS

The above features and other advantages of the present invention will be more clearly understood from the following detailed description taken in conjunction with the accompanying drawings, in which:

FIG. 1a shows X-ray photoelectron spectroscopy (XPS) spectra of a chalcogenide thin film prepared in Example 1 of the present invention;

FIG. 1b shows depth files at 200° C. and 30° C. for a chalcogenide thin film prepared in Example 1 of the present invention;

FIG. 1c is a Rutherford backscattering spectroscopy (RBS) spectrum of a chalcogenide thin film prepared in Example 1 of the present invention;

FIG. 2 shows atomic force microscopy (AFM) images of a chalcogenide thin film prepared in Example 1 of the present invention;

FIG. 3 is a transmission electron microscopy (TEM) image of a chalcogenide thin film prepared in Example 1 of the present invention;

FIG. 4 shows an X-ray diffraction (XRD) pattern of a chalcogenide thin film prepared in Example 1 of the present invention;

FIG. 5 is a UV absorption spectrum of a chalcogenide thin film prepared in Example 1 of the present invention;

FIG. 6 shows an X-ray diffraction (XRD) pattern of a chalcogenide thin film prepared in Example 6 of the present invention;

FIG. 7 shows a MIM-structured test device comprising a chalcogenide thin film fabricated in Experimental Example 1 of the present invention; and

FIG. 8 is a graph showing the current-voltage characteristics of a test device comprising a chalcogenide thin film fabricated in Experimental Example 1 of the present invention.

### DESCRIPTION OF PREFERRED EMBODIMENTS

The present invention will now be described in more detail with reference to the accompanying drawings.

The present invention provides a chalcogenide precursor compound represented by Formula 1 below:

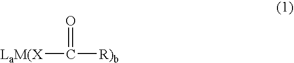

wherein L is a ligand having a nitrogen atom with an unshared pair of electrons;

M is a metal atom selected from the group consisting of Group II, III and IV elements;

X is a Group VI chalcogen element;

R is hydrogen, substituted or unsubstituted C₁-C₃₀ alkyl, substituted or unsubstituted C₁-C₃₀ alkenyl, substituted or unsubstituted C₁-C₃₀ alkynyl, substituted or unsubstituted C₁-C₃₀ alkoxy, substituted or unsubstituted C₆-C₃₀ aryl, substituted or unsubstituted C₆-C₃₀ aryloxy, substituted or unsubstituted C₂-C₃₀ heteroaryl, substituted or unsubstituted C₂-C₃₀ heteroaryloxy, or substituted or unsubstituted C₂-C₃₀ heteroarylalkyl;

a is an integer from 0 to about 2; and

b is about 2 or about 3.

The electrical resistance state and photonic structure of chalcogenide semiconductors are changed by changing applied voltages and by changing the intensity of light irradiation, respectively. Based on these characteristics, chalcogenide semiconductors can be used in switching devices and optical memory devices. Generally, molecules present in thin films prepared from inorganic materials are arranged in ordered, extended inorganic lattices of covalent bonds, thereby leading to a great increase in charge carrier mobility. However, inorganic materials are relatively insoluble in organic solvents, making it impossible to prepare high-quality films by solution deposition. Due to the presence of the bound ligand, such as lutidine, and the condensable organic reactive group linked to the chalcogen element, the solubility of the chalcogenide in organic solvents is increased to facilitate the processing of solution deposition, and as a result, the problem of poor solubility of the chalcogenide can be overcome.

Specific compounds of Formula 1 are those wherein L is selected from the group consisting of 2,3-lutidine, 2,4-lutidine, 2,5-lutidine, 2,6-lutidine, 3,4-lutidine, 3,5-lutidine, 3,6-lutidine, 2,6-lutidine-α²,3-diol, 2-hydroxypyridine, 3-hydroxypyridine, 4-hydroxypyridine, 2-hydroxyquinoline, 6-hydroxyquinoline, 8-hydroxyquinoline, 8-hydroxy-2-quinolinecarbonitrile, 8-hydroxy-2-quinolinecarboxylic acid, 2-hydroxy-4-(trifluoromethyl)pyridine and N,N,N,N-tetramethylethylenediamine, M is selected from the group consisting of cadmium (Cd), zinc (Zn), mercury (Hg), gallium (Ga), indium (In), lead (Pb) and tin (Sn), and X is selected from the group consisting of sulfur (S), selenium (Se) and tellurium (Te).

More specific chalcogenide precursor compounds of Formula 1 are represented by Formula 2 and Formula 3 below:

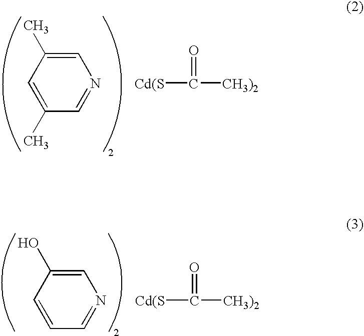

The present invention also provides a method for preparing a chalcogenide thin film, the method comprising the steps of:

i) dissolving a chalcogenide precursor compound represented by Formula 1 below in organic solvent to prepare a precursor solution:

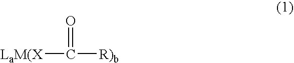

wherein L is a ligand having a nitrogen atom with an unshared pair of electrons;

M is a metal atom selected from the group consisting of Group II, III and IV elements;

X is a Group VI chalcogen element;

R is hydrogen, substituted or unsubstituted C₁-C₃₀ alkyl, substituted or unsubstituted C₁-C₃₀ alkenyl, substituted or unsubstituted C₁-C₃₀ alkynyl, substituted or unsubstituted C₁-C₃₀ alkoxy, substituted or unsubstituted C₆-C₃₀ aryl, substituted or unsubstituted C₆-C₃₀ aryloxy, substituted or unsubstituted C₂-C₃₀ heteroaryl, substituted or unsubstituted C₂-C₃₀ heteroaryloxy, or substituted or unsubstituted C₂-C₃₀ heteroarylalkyl;

a is an integer from 0 to about 2; and

b is about 2 or about 3, in an organic solvent to prepare a precursor solution;

ii) applying the precursor solution to a substrate, followed by annealing.

Specific compounds of Formula 1 are those wherein L is selected from the group consisting of 2,3-lutidine, 2,4-lutidine, 2,5-lutidine, 2,6-lutidine, 3,4-lutidine, 3,5-lutidine, 3,6-lutidine, 2,6-lutidine-α²,3-diol, 2-hydroxypyridine, 3-hydroxypyridine, 4-hydroxypyridine, 2-hydroxyquinoline, 6-hydroxyquinoline, 8-hydroxyquinoline, 8-hydroxy-2-quinolinecarbonitrile, 8-hydroxy-2-quinolinecarboxylic acid, 2-hydroxy-4-(trifluoromethyl)pyridine and N,N,N,N-tetramethylethylenediamine, M is selected from the group consisting of cadmium (Cd), zinc (Zn), mercury (Hg), gallium (Ga), indium (In), lead (Pb) and tin (Sn), and X is selected from the group consisting of sulfur (S), selenium (Se) and tellurium (Te).

More specific chalcogenides of Formula 1 are represented by Formula 2 and Formula 3 below:

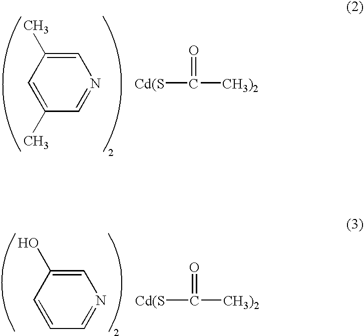

The coating solution can be prepared by mixing at least two different kinds of the chalcogenide represented by Formula 1.

Non-limiting examples of suitable organic solvents that can be used in the present invention include aliphatic hydrocarbon solvents, such as hexane and heptane; aromatic hydrocarbon solvents, such as pyridine, quinoline, anisole, mesitylene and xylene; ketone-based solvents, such as methyl isobutyl ketone, 1-methyl-2-pyrrolidinone, cyclohexanone and acetone; ether-based solvents, such as tetrahydrofuran and isopropyl ether; acetate-based solvents, such as ethyl acetate, butyl acetate and propylene glycol methyl ether acetate; alcohol-based solvents, such as isopropyl alcohol and butyl alcohol; amide-based solvents, such as dimethylacetamide and dimethylformamide; silicon-based solvents; and a combination comprising at least one of the foregoing.

The substrate coated with the chalcogenide thin film is not limited to any particular substrate. Examples of suitable substrates include any substrate capable of withstanding heat-curing conditions, for example, glass substrates, silicon wafers, ITO glass, quartz, silica-coated substrates, alumina-coated substrates, and plastic substrates. These substrates can be selected depending upon the intended applications.

The application of the chalcogenide precursor solution to the substrate may be carried out by a coating process, spin coating, dip coating, roll coating, screen coating, spray coating, spin casting, flow coating, screen printing, ink jet, or drop casting. In view of ease of application and uniformity, spin coating is most preferred coating process. Upon spin coating, the spin speed is preferably adjusted within the range of about 100 to about 10,000 rpm.

After the chalcogenide precursor solution is applied to the substrate, annealing is carried out to prepare the final is chalcogenide thin film. The annealing step includes the sub-steps of baking the precursor solution coated on the substrate and curing the precursor solution.

The baking is performed to evaporate the remaining organic solvent and dry the precursor solution. Due to the van der Waals attraction and dipole-dipole interactions, packing occurs between the chalcogenide molecules. The baking can be performed by simply exposing the precursor solution to the atmosphere, subjecting the precursor solution to a vacuum in the initial stage of the subsequent curing, or heating the precursor solution to a temperature of about 50° C. to about 100° C. in a nitrogen atmosphere for one second to five minutes.

Next, the curing is performed to thermally degrade and condense the bound ligand to form a hexagonal structure of M-X. Specifically, the precursor solution is heat-cured at about 150 to about 400° C. for about 1 to about 60 minutes to form the final chalcogenide thin film. The curing can be performed by irradiating the precursor solution with UV light at about 200 to about 450 nanometers (nm). The wavelength of the UV light can be varied within the range depending on the absorption wavelength of the bound ligand and the chalcogenide.

Since the chalcogenide thin film prepared by the method of the present invention has a band gap similar to that of a bulk chalcogenide thin film and exhibits excellent crystallinity, it can be used as a semiconducting layer in a variety of electronic devices. In addition, the chalcogenide thin film can be prepared by a solution deposition process, thus contributing to the simplification of procedures and reduction of preparation costs. The chalcogenide thin film can therefore be useful in a wide variety of applications, such as thin film transistors, electroluminescent devices, photovoltaic cells and memory devices.

Hereinafter, the present invention will be explained in more detail with reference to the following examples. However, these examples are for purposes of illustration only and are not to be construed as limiting the scope of the invention.

### PREPARATIVE EXAMPLE 1

### Synthesis of Chalcogenide Precursor Lut₂Cd(S(CO)CH₃)₂ (Wherein Lut=3,5-Lutidine)

First, 1.0 grams (g) (5.8 mmol) of cadmium carbonate, 1.2 g (11.6 mmol) of 3,5-lutidine and 20 milliliters (ml) of toluene were mixed together in a round-bottom flask. 0.9 g (11.6 mmol) of thioacetic acid was added dropwise to the mixture with vigorous stirring. The resulting mixture was stirred at room temperature for one hour. As the reaction proceeded, the solid cadmium carbonate disappeared, CO₂ bubbling was observed, and the reaction solution turned yellow in color. The toluene and other volatile reaction by-products were removed under reduced pressure to obtain a white crystalline solid and a small amount of a yellow solid, which is presumably cadmium sulfide. The solids were added to toluene, and filtered to remove the yellow solid. Next, the filtrate was placed in a freezer to obtain ca. 2.0 to 2.5 g of Lut₂Cd(S(CO)CH₃)₂ (yield: 59 to 74%) as a colorless crystal.

NMR Data

¹H NMR (C₆D₆): 1.69 [12H, CH₃-lutidine], 2.58 [6H, SOC CH₃], 6.55 [2H, lutidine para-CH], 8.50 [4H, lutidine ortho-CH]; ¹³C NMR: 17.8 [CH₃-lutidine], 35.1 [SOCCH₃], 133.7 [C—CH₃-lutidine], 138.8 [para-CH-lutidine], 147.7 [ortho CH-lutidine]; ¹¹³Cd NMR: 353.5.

### PREPARATIVE EXAMPLE 2

### Synthesis of Chalcogenide Precursor L₂Cd(S(CO)CH₃)₂ (Wherein L=3-Hydroxypyridine)

First, 1.0 g (5.8 mmol) of cadmium carbonate, 0.92 g (11.6 mmol) of 3-hydroxypyridine and 20 ml of toluene were mixed together in a round-bottom flask. The flask was surrounded with ice water. Thereafter, 0.9 g (11.6 mmol) of thioacetic acid was added dropwise to the mixture while stirring vigorously. The resulting mixture was stirred for one hour. As the reaction proceeded, the solid cadmium carbonate disappeared, CO₂ bubbling was observed, and the reaction solution turned yellow in color. After the reaction was allowed to proceed until no gas evolution was observed, the solvent was completely removed to obtain a sold. The solid was washed with THF 3 to 4 times, filtered, and dried, yielding L₂Cd(S(CO)CH₃)₂ (L=3-hydroxypyridine) as a colorless crystal.

NMR Data

¹H NMR (DMSO): 2.49 [6H, SOCCH₃], 7.14 [2H, 3-hydroxypyridine para-CH], 7.16 [2H, 3-hydroxypyridine 5-meta-CH], 8.11 [2H, 3-hydroxypyridine 2-ortho-CH], 8.00 [2H, 3-hydroxypyridine 6-ortho-CH]; ¹³C NMR: 35.1 [SOCCH₃], 133.7 [C—CH₃-lutidine], 138.8 [para-CH-lutidine], 147.7 [ortho CH-lutidine];¹¹³Cd NMR: 353.5.

### EXAMPLE 1

First, 0.2 g of the chalcogenide prepared in Preparative Example 1 was dissolved in 1.8 g of pyridine. The solution was stirred to prepare a precursor solution for the preparation of a chalcogenide thin film. The coating solution was spin-coated at 500 revolutions per minute (rpm) on a 4 inch silicon wafer for 20 seconds, baked on a hot plate in a nitrogen atmosphere at 100° C. for one minute to obtain a film. The film was cured in a nitrogen atmosphere at 150 to 400° C. for 1 to 60 minutes to prepare a chalcogenide thin film.

### EXAMPLES 2-5

Chalcogenide thin films were prepared in the same manner as in Example 1, except that 0.06 g, 0.1 g, 0.2 g and 0.4 g of the chalcogenide prepared in Preparative Example 1 each was dissolved in 1.8 g of pyridine to prepare four precursor solutions.

### EXAMPLE 6

A chalcogenide thin film was prepared in the same manner as in Example 1, except that the spin-coated chalcogenide precursor solution was irradiated with UV light at 200 to 400 nm, and then cured.

### EXPERIMENTAL EXAMPLE 1

First, Al was deposited on a previously washed glass substrate by sputtering. The aluminum layer acts as a bottom electrode and has a thickness of 2,000 Angstroms (A). A mixture of the chalcogenide precursor (0.2 g) prepared in Preparative Example 1 and pyridine (1.8 g) was spin-coated on the bottom electrode to form a 500 Å-thick CdS semiconductor layer. Thereafter, Al was deposited on the CdS semiconductor layer to form a top electrode (diameter=0.5 mm, thickness=2,000 Å), completing fabrication of a test device. The current-voltage characteristics of the test device were evaluated. The MIM-structured test device is shown in FIG. 7.

### EXPERIMENTAL EXAMPLE 2

The L₂Cd(S(CO)CH₃)₂ (wherein L=3-hydroxypyridine) precursor prepared in Preparative Example 2 was dissolved in pyridine to prepare 10 wt % solution. The solution was spin-coated at 500 rpm on a Si substrate to form a thin film. The resulting structure was baked at 100° C. for one minute followed by curing at a substrate temperature of 200 to 300° C. to form a CdS thin film with a thickness of 500 to 1,000 Å. The procedure of Experimental Example 1 was repeated to fabricate a test device having an Al—CdS—Al MIM structure.

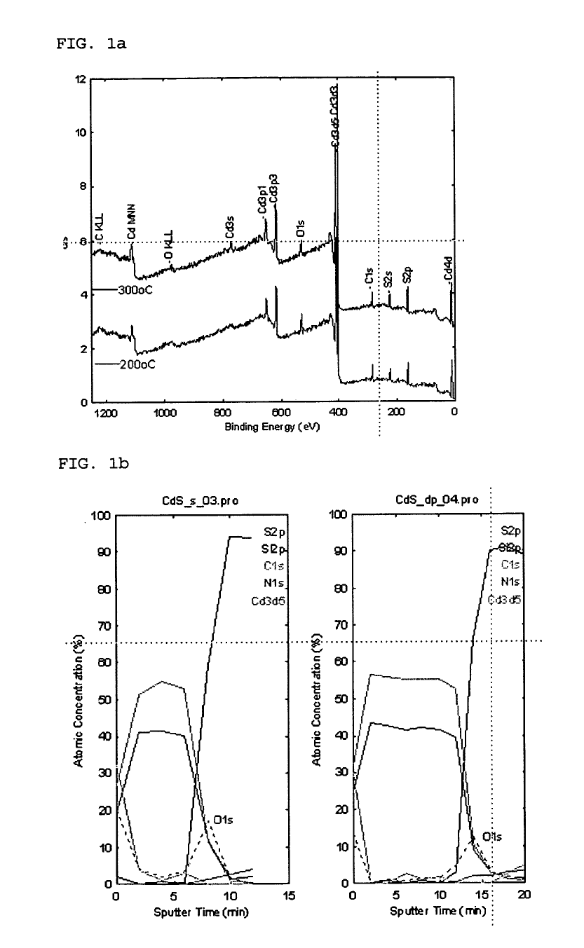

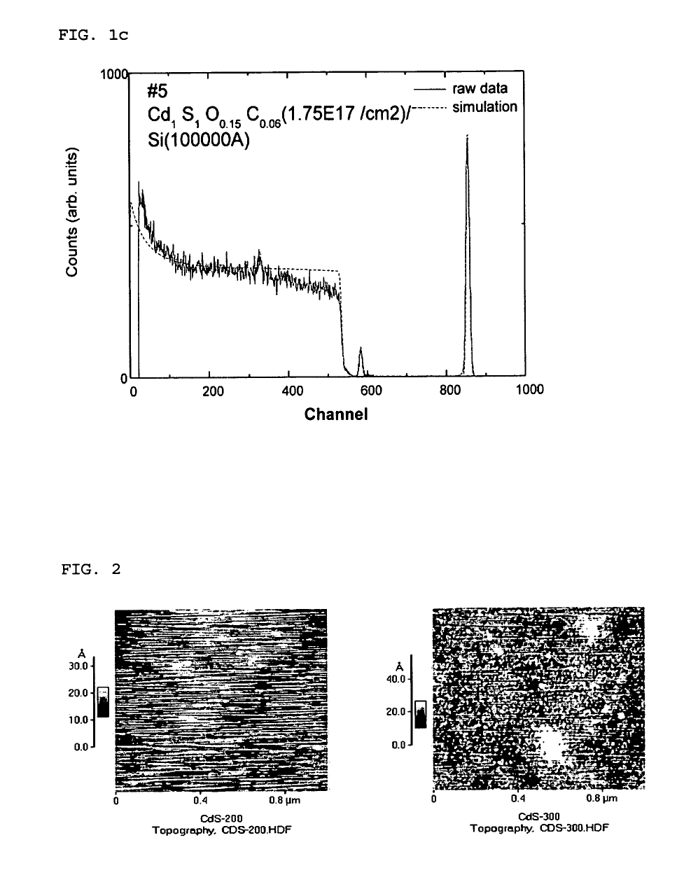

The composition, surface texture, crystallinity and UV absorbance of the chalcogenide thin film prepared in Example 1 were examined, and the obtained results are shown in FIGS. 1a-1c and 2-5.

First, the composition of the chalcogenide thin film prepared in Example 1 was measured, and the results are shown in FIGS. 1a-1c. Specifically, FIG. 1a shows X-ray photoelectron spectroscopy (XPS) spectra, FIG. 1b shows depth files at 200° C. and 30° C., and FIG. 1c is a Rutherford backscattering spectroscopy (RBS) spectrum, which is a measure of the stoichiometric ratio Cd/S, of the chalcogenide thin film prepared in Example 1. The results shown in FIGS. 1a-1c reveal that the ratio S/Cd in the CdS thin film was about 1.

The surface texture of the chalcogenide thin film prepared in Example 1 was observed, and the results are shown in FIG. 2. The images shown in FIG. 2 indicate that no grain boundary was observed on the surface of the chalcogenide thin film and that crystals were very uniformly formed. This demonstrates that the solution deposition provides better results in terms of texture and morphology than chemical bath deposition (CBD) or ESAVD. In addition, the chalcogenide thin film is expected to give excellent interfacial stability when applied to devices.

The crystallinity of the chalcogenide thin film prepared in Example 1 was analyzed and the results are shown in FIG. 3. FIG. 3 is a cross-sectional transmission electron microscopy (TEM) image of the chalcogenide thin film. Results of the analysis show that nanocrystal domains having a diameter of 5 to 10 nm were formed in any direction. The chalcogenide thin film had a density of 4.21 g/cm³, as determined by XRR. Given that a standard density is the density (4.83 grams per cubic centimeter (g/cm³)) of the bulk CdS, the porosity of the chalcogenide thin film was calculated according to the following Equation:
Porosity=(1−measured density/standard density)×100(%)=(1−4.21/4.83)×100(%)=13%.

The white portions shown in the image represents nanopores free of chalcogenide networks.

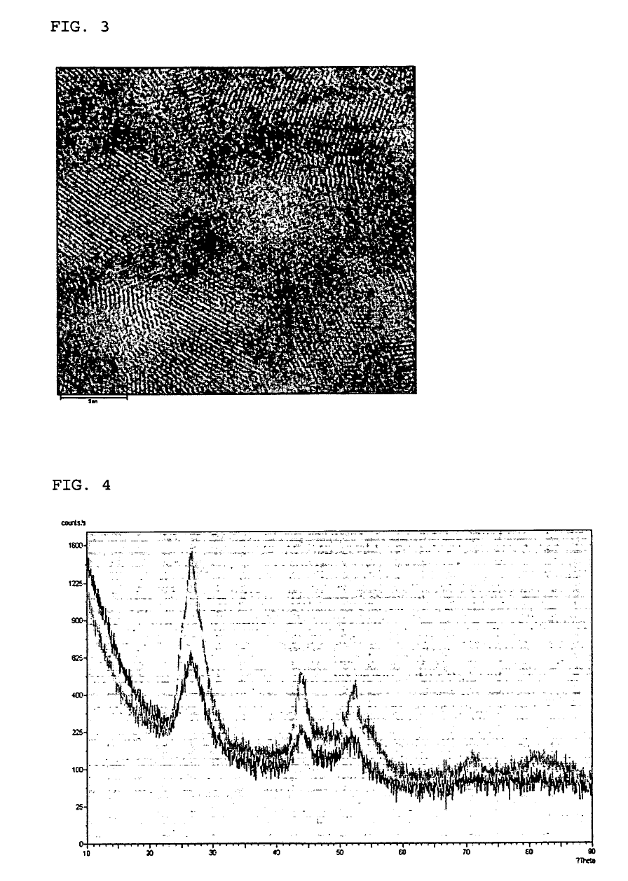

The crystallinity of the chalcogenide thin film prepared in Example 1 was analyzed and the results are shown in FIG. 4. Specifically, FIG. 4 shows XRD pattern of the chalcogenide thin film. The CdS peaks shown in FIG. 4 reveal the formation of a hexagonal CdS nanocrystal.

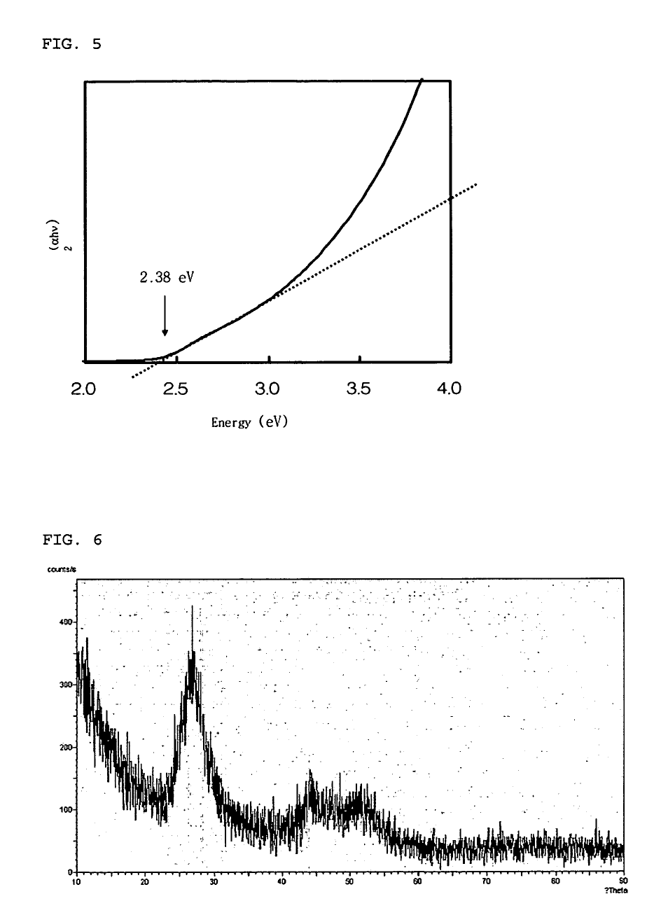

FIG. 5 is a Tauc plot of UV absorbance of the chalcogenide thin film prepared in Example 1. It is estimated from FIG. 5 that the chalcogenide thin film has a band gap of 2.38 eV or more. This reveals that the chalcogenide film prepared by the method of the present invention can be utilized as a material for a semiconductor layer.

Next, the thickness and refractive index of the chalcogenide thin films prepared in Examples 2-5 were measured using a spectroscopic ellipsometer (EC-400, J. A. Woollam Co. Inc.). The results are shown in Table 1 below.

TABLE 1

| | Example No. | | | |
|---|---|---|---|---|
| | Example 2 | Example 3 | Example 4 | Example 5 |
| Concentration (%) | 3 | 5 | 10 | 20 |
| Thickness (Å) | 33 | 90 | 255 | 612 |
| Refractive index | 3.07 | 2.62 | 2.33 | 2.15 |
| (at 632.8 nm) | | | | |

It is obvious from the results shown in Table 1 that the optical properties of the semiconductor thin films can be controlled by varying the concentration of the chalcogenide in the precursor solutions.

The crystallinity of the chalcogenide thin film prepared in Example 6 was analyzed and the results are shown in FIG. 6. The pattern shown in FIG. 6 reveals the presence of peaks of a hexagonal CdS nanocrystal. This demonstrates that hexagonal CdS nanocrystal domains were formed even after the chalcogenide precursor solution was UV cured, like after heat curing.

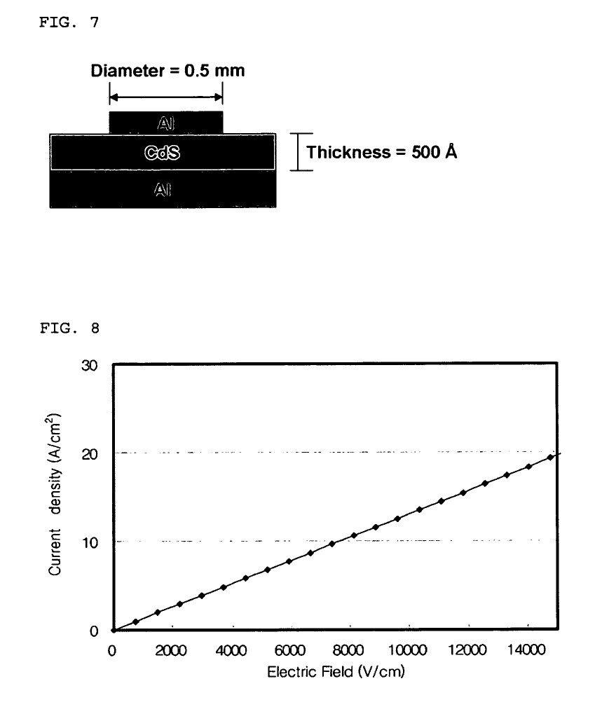

To measure the resistivity of the test device fabricated in Experimental Example 1, current-voltage characteristics were plotted. Taking into consideration the thickness of the CdS thin film and the area of the top electrode, a graph of current density versus electric field was obtained from the current-voltage curve in the voltage range of 0 to 200 mV. The graph is shown in FIG. 8. The ohmic contact characteristics were confirmed in the MIM structure. In addition, the resistivity of the device was measured and displayed a resistivity of 765 Ω·cm in the tested voltage range. The measured resistivity falls within the resistivity range (10⁻²- to 10⁹ Ω·cm) of general semiconductor materials.

Further, the current-voltage characteristics of the test device fabricated in Experimental Example 2 were plotted. As a result, the ohmic contact characteristics of the test device were confirmed. The device was measured to have a resistivity of 700-1,000 Ω·cm, as calculated from the slope. When the resistivity value of the test device fabricated in Experimental Example 2 is compared with that of the test device fabricated in Experimental Example 1, there is little difference in the electrical properties of the CdS thin films despite different pyridine ligands.

According to the present invention, the chalcogenide compound can be used to form a semiconductor thin film, and a solution deposition process, e.g., spin coating, can be applied to form a thin film. Accordingly, the chalcogenide compound can be effectively used in the fabrication of thin film transistors, electroluminescent devices, photovoltaic cells, and memory devices.

As apparent from the above description, according to the method of the present invention, the use of an inorganic chalcogenide semiconductor material soluble in organic solvents enables the preparation of a chalcogenide thin film having excellent electrical and physical properties (e.g., crystallinity). In addition, a large-area thin film can be prepared by a solution deposition process, e.g., spin coating or dip coating, thus contributing to a reduction in preparation costs. Other commercial articles can also be manufactured using the chalcogenide thin film developed from the processes described herein. A chalcogenide thin film prepared by the method of the present invention can be effectively utilized in a wide variety of applications, such as thin film transistors, electroluminescent devices and photovoltaic cells.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A chalcogenide precursor compound represented by Formula 1 below: 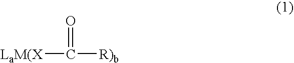
wherein L is a ligand having a nitrogen atom with an unshared pair of electrons;
M is a metal atom selected from the group consisting of Group II, III and IV elements;
X is a Group VI chalcogen element;
R is hydrogen, substituted or unsubstituted C₁-C₃₀ alkyl, substituted or unsubstituted C₁-C₃₀ alkenyl, substituted or unsubstituted C₁-C₃₀ alkynyl, substituted or unsubstituted C₁-C₃₀ alkoxy, substituted or unsubstituted C₆-C₃₀ aryl, substituted or unsubstituted C₆-C₃₀ aryloxy, substituted or unsubstituted C₂-C₃₀ heteroaryl, substituted or unsubstituted C₂-C₃₀ heteroaryloxy, or substituted or unsubstituted C₂-C₃₀ heteroarylalkyl;
a is an integer from 0 to about 2; and
b is about 2 or about 3.

2. The chalcogenide precursor compound according to claim 1, wherein L is selected from the group consisting of 2,3-lutidine, 2,4-lutidine, 2,5-lutidine, 2,6-lutidine, 3,4-lutidine, 3,5-lutidine, 3,6-lutidine, 2,6-lutidine-α²,3-diol, 2-hydroxypyridine, 3-hydroxypyridine, 4-hydroxypyridine, 2-hydroxyquinoline, 6-hydroxyquinoline, 8-hydroxyquinoline, 8-hydroxy-2-quinolinecarbonitrile, 8-hydroxy-2-quinolinecarboxylic acid, 2-hydroxy-4-(trifluoromethyl)pyridine, and N,N,N,N-tetramethylethylenediamine.

3. The chalcogenide precursor compound according to claim 1, wherein M is selected from the group consisting of cadmium (Cd), zinc (Zn), mercury (Hg), gallium (Ga), indium (In), lead (Pb) and tin (Sn), and X is selected from the group consisting of sulfur (S), selenium (Se) and tellurium (Te).

4. The chalcogenide precursor compound according to claim 1, wherein the chalcogenide precursor compound is represented by Formula 2 below:

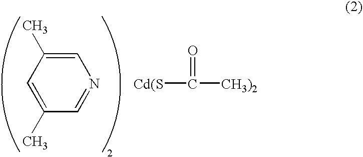

5. The chalcogenide precursor compound according to claim 1, wherein the chalcogenide precursor compound is represented by Formula 3 below:

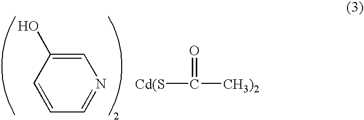

6. A method for preparing a chalcogenide thin film, the method comprising the steps of:
i) dissolving a chalcogenide precursor compound represented by Formula 1 below in organic solvent to prepare a precursor solution: 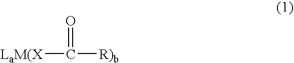
wherein L is a ligand having a nitrogen atom with an unshared pair of electrons;
M is a metal atom selected from the group consisting of Group II, III and IV elements;
X is a Group VI chalcogen element;
R is hydrogen, substituted or unsubstituted C₁-C₃₀ alkyl, substituted or unsubstituted C₁-C₃₀ alkenyl, substituted or unsubstituted C₁-C₃₀ alkynyl, substituted or unsubstituted C₁-C₃₀ alkoxy, substituted or unsubstituted C₆-C₃₀ aryl, substituted or unsubstituted C₆-C₃₀ aryloxy, substituted or unsubstituted C₂-C₃₀ heteroaryl, substituted or unsubstituted C₂-C₃₀ heteroaryloxy, or substituted or unsubstituted C₂-C₃₀ heteroarylalkyl;
a is an integer from 0 to about 2; and
b is about 2 or about 3, in an organic solvent to prepare a precursor solution;
ii) applying the precursor solution to a substrate, followed by annealing.

7. The method according to claim 6, wherein L is selected from the group consisting of 2,3-lutidine, 2,4-lutidine, 2,5-lutidine, 2,6-lutidine, 3,4-lutidine, 3,5-lutidine, 3,6-lutidine, 2,6-lutidine-α²,3-diol, 2-hydroxypyridine, 3-hydroxypyridine, 4-hydroxypyridine, 2-hydroxyquinoline, 6-hydroxyquinoline, 8-hydroxyquinoline, 8-hydroxy-2-quinolinecarbonitrile, 8-hydroxy-2-quinolinecarboxylic acid, 2-hydroxy-4-(trifluoromethyl)pyridine, and N,N,N,N-tetramethylethylenediamine.

8. The method according to claim 6, wherein M is selected from the group consisting of cadmium (Cd), zinc (Zn), mercury (Hg), gallium (Ga), indium (In), lead (Pb) and tin (Sn), and X is selected from the group consisting of sulfur (S), selenium (Se) and tellurium (Te).

9. The method according to claim 6, wherein the chalcogenide precursor compound is represented by Formula 2 below:

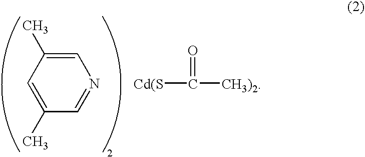

10. The method according to claim 6, wherein the chalcogenide precursor compound is represented by Formula 3 below:

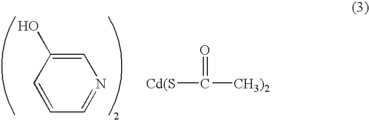

11. The method according to claim 6, wherein the organic solvent is selected from the group consisting of aliphatic hydrocarbon solvents, hexane, heptane; aromatic hydrocarbon solvents, pyridine, quinoline, anisole, mesitylene, xylene; ketone-based solvents, methyl isobutyl ketone, 1-methyl-2-pyrrolidinone, cyclohexanone, acetone; ether-based solvents, tetrahydrofuran, isopropyl ether; acetate-based solvents, ethyl acetate, butyl acetate, propylene glycol methyl ether acetate; alcohol-based solvents, isopropyl alcohol, butyl alcohol; amide-based solvents, dimethylacetamide, dimethylformamide; silicon-based solvents; and a combination comprising at least one of the foregoing solvents.

12. The method according to claim 6, wherein the precursor solution is applied to the substrate by spin coating, dip coating, roll coating, screen coating, spray coating, spin casting, flow coating, screen printing, ink jet, or drop casting.

13. The method according to claim 6, wherein the annealing step includes the sub-steps of: baking the precursor solution coated on the substrate; and curing the precursor solution.

14. The method according to claim 13, wherein the baking is performed in a nitrogen atmosphere at about 50 to about 100° C. for about one second to about five minutes.

15. The method according to claim 13, wherein the curing is performed in a nitrogen atmosphere at about 150 to about 600° C. for about 1 to about 60 minutes.

16. The method according to claim 13, wherein the curing is performed by UV irradiation.

17. A chalcogenide thin film prepared by the method according to claim 5.

18. An electronic device comprising the chalcogenide thin film of claim 17 as a carrier transport layer.

19. The electronic device according to claim 18, wherein the electronic device is a thin film transistor, an electroluminescent device, a photovoltaic cell, or a memory device.
